(19) United States
(12) Patent Application Publication
(10) Pub. No.: US 2006/0111163 A1
(43) Pub. Date: May 25, 2006

(54) FM transmission antenna device in a portable terminal

(75) Inventor: Gung-Gun Oh, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/252,847

(22) Filed: Oct. 19, 2005

(30) Foreign Application Priority Data
Nov. 25, 2004 (KR) 2004-97672

(51) Int. Cl. H04M 1/00

(52) U.S. Cl. 455/575.7; 455/550.1; 455/575.1

(57) ABSTRACT

An FM transmission antenna device in a portable terminal is provided. In the FM transmission antenna device, an antenna pattern is attached to a surface of the portable terminal, an FPC extends from the antenna pattern, and a connector is provided at an end of the FPC, for connecting the FPC to an FM transmitter.

### PRIORITY

This application claims the benefit under 35 U.S.C. §119(a) of an application entitled “FM Transmission Antenna Device in a Portable Terminal” filed in the Korean Intellectual Property Office on Nov. 25, 2004 and assigned Serial No. 2004-97672, the entire content of which is hereby incorporated by reference.

### BACKGROUND OF THE INVENTION

1.Field of the Invention

The present invention relates generally to a portable terminal. More particularly, the present invention relates to a transmission antenna device in a portable terminal, for outputting a voice signal and sound from the portable terminal to an external sound device.

2.Description of the Related Art

A portable terminal is typically a device that provides wireless communications between users or between a user and a service provider through a base station. Initially, in the early development of portable terminals, only limited mobile communication services like voice service and short message transmission were provided. Now, however, a variety of mobile content is increasingly available, including mobile banking, on-line games, and Video-On-Demand (VOD).

The expansion of mobile communications through the portable terminal is a driving force behind providing additional, diverse functions for portable terminals, like music file reproduction and image capturing and playing, which go beyond the simple input and output of voice signals and text information.

Also, as compression technology for music files and images has been further developed, high-quality sounds and images can be stored with less memory capacity. Thus, multimedia files can be stored directly in and enjoyed with the portable terminal.

However, the limited size of an output device in the portable terminal, that is, a display and a speaker, places limits on the improvement of the quality of image and sound output. Moreover, since the volume of the speaker is limited, a separate earphone is needed to enjoy high-quality sound. If a user is driving, he may have difficulty in hearing surrounding noises while listening to music through an earphone. This may be distracting to a driver. In addition, a user may not recognize an event like an incoming voice call or message while listening to music through the earphone.

Accordingly, there is a need for an improved portable terminal which has an improved quality of image and sound output.

### SUMMARY OF THE INVENTION

An aspect of the present invention is to address at least the above problems and/or disadvantages and to provide at least the advantages described below. Accordingly, an aspect of the present invention is to provide a frequency modulation (FM) transmission antenna device in a portable terminal that outputs sound from the portable terminal to an external device by use of an FM transmitter.

Another aspect of the present invention is to provide an FM transmission antenna device in a portable terminal that outputs voice through a speaker mounted in a vehicle.

In accordance with an aspect of the present invention, a portable terminal has an FM transmission antenna device. The FM transmission antenna device has an antenna pattern which is attached to a surface of the portable terminal. A flexible printed circuit (FPC) FPC extends from the antenna pattern, and a connector is provided at an end of the FPC to connect the FPC to an FM transmitter.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of a portable terminal having an FM transmission antenna device according to an exemplary embodiment of the present invention;

FIG. 2 is an exploded perspective view of the FM transmission antenna device in the portable terminal illustrated in FIG. 1; and

FIG. 3 is a view describing the operation of the FM transmission antenna device illustrated in FIG. 2.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

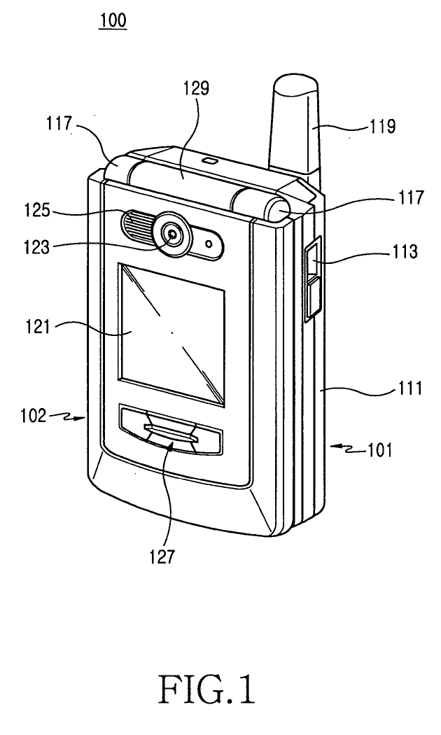

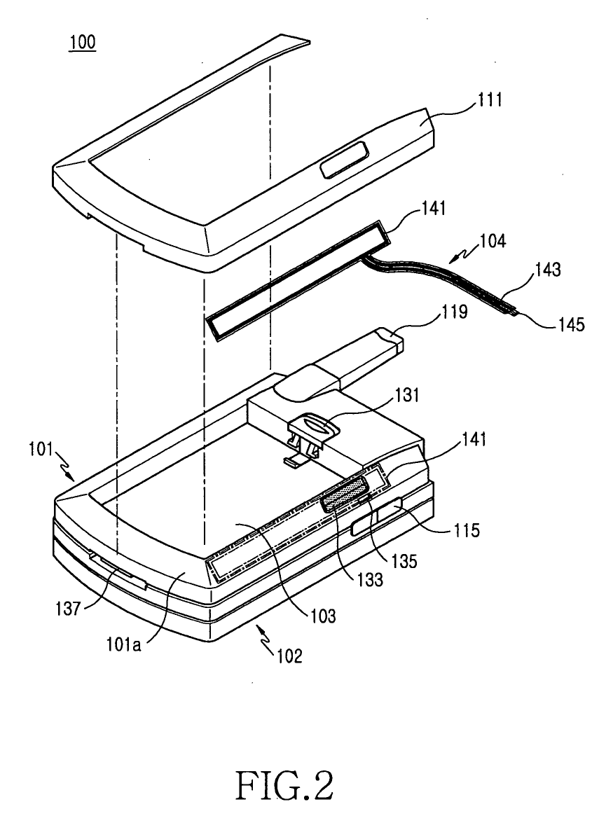

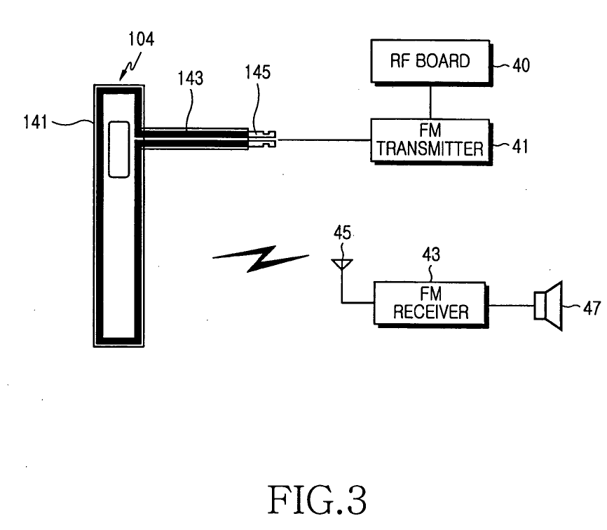

FIG. 1 is a perspective view of a portable terminal having an FM transmission antenna device according to an exemplary embodiment of the present invention. FIG. 2 is an exploded perspective view of the FM transmission antenna device in the portable terminal illustrated in FIG. 1. FIG. 3 is a view describing the operation of the FM transmission antenna device illustrated in FIG. 2.

Referring to FIGS. 1 and 2, a portable terminal 100 equipped with an FM transmission antenna device 104 according to an exemplary embodiment of the present invention is preferably a folder-type terminal including a first housing 101 and a second housing 102 configured to rotate away from or toward the first housing 101, in a face to face configuration.

The first housing 101 is provided, at an upper end thereof, with a pair of side hinge arms 117 that face apart from each other. The second housing 102 is provided, at an end thereof, with a center hinge arm 129. The center hinge arm 129 is rotatably engaged between the side hinge arms 117, and therefore the second housing 102 is rotatably engaged with the first housing 101.

While not shown, a keypad and a transmitter are provided on an inner surface of the first housing 101, and a main display and a receiver reside on an inner surface of the second housing 102. As the second housing 102 rotates over the first housing 101, the keypad, the transmitter, the main display and the receiver are opened and closed.

The first housing 101 is further provided with a volume control key 115 and an ear-microphone jack 113 on both sides thereof, with an antenna device 119 at the upper end thereof, with an interface connector 137 at a lower end thereof, and with speakers 133 substantially symmetrical to each other on both sides thereof.

A sub-display 121 and an auxiliary keypad 127 for invoking limited functions are provided on an outer surface of the second housing 102. In some portable terminal products, a camera 123 and a flash 125 are provided in the vicinity of the sub-display 121, for capturing images.

When the portable terminal 100 is placed in a play mode to play multimedia files including music and moving pictures, the auxiliary keypad 127 may be used to invoke related functions. Thus, the auxiliary keypad 127 can be configured to include “Play/Stop”, “Fast Forward” and “Rewind” keys.

The portable terminal 100 has the FM transmission antenna device 104 in addition to the antenna device 119 for communicating with the base station.

The FM transmission antenna device 104 includes an antenna pattern 141 attached to a portion of an outer surface 101a of the first housing 101, and a flexible printed circuit (FPC) 143 for connecting the antenna pattern 141 to an FM transmitter 41 (shown in FIG. 3) which is mounted to a radio frequency (RF) board 40 (also shown in FIG. 3).

The antenna pattern 141 can be formed by bending a conductive plate of sheet metal, or it can be formed by an FPC having a printed circuit pattern of a thin copper film and coated with an insulation material. Referring to FIG. 2, the antenna pattern 141 is preferably fabricated in the form of a loop antenna attached onto the outer surface 101a of the first housing 101.

The FPC 143 extends from the antenna pattern 141 into the first housing 101 through a hole 135 formed in the outer surface 101a of the first housing 101. An end of the FPC 145 is formed into a connector 145 by melting or attaching a rigid conductive plate, for connecting to the FM transmitter 41. Therefore, the antenna pattern 141 is connected to the FM transmitter 41 via the FPC 143 and the connector 145.

The portable terminal 100 is provided with a dummy cover 111 for protecting the FM transmission antenna device 104 attached onto the outer surface of the first housing 101 and improving the appearance of the portable terminal 100. The dummy cover 111 is preferably configured to cover both sides and a lower side of the outer surface of the portable terminal.

When the portable terminal 100 resides near an external sound device, for example, an audio device for a vehicle, the FM transmitter 41 and the FM transmission antenna device 104 outputs sound from the portable terminal to the external sound device if the user puts the portable terminal 100 into a broadcasting mode.

With reference to FIG. 3, a description will be made of the operation for outputting sound from the portable terminal 100 through the external sound device using the FM transmitter 41 and the FM transmission antenna 104. When an external sound device capable of FM reception is available while the portable terminal 100 is in a voice call mode or a multimedia file play mode, the user places the portable terminal 100 into the broadcasting mode. The portable terminal 100 transmits the sound of a multimedia file being played in the broadcasting mode through the FM transmitter 41 and the FM transmission antenna device 104. The transition to broadcasting mode is preferably performed by manipulating the keypad installed on the first housing 101 and the auxiliary keypad 127 provided on the outer surface of the second housing 102.

The signal from the portable terminal 100 is detected by an antenna 45 and an FM receiver 43 of the external sound device (such as an audio device for a vehicle) and then output through a speaker 47. Therefore, the user can enjoy sound from the portable terminal 100 via the external sound device without using an additional earphone.

In accordance with the present invention as described above, in addition to the antenna device for transmitting/receiving signals with a base station, the portable terminal is further provided with an FM transmission antenna device that is configured to transmit a sound signal from a multimedia file being played to an external sound device. Therefore, multimedia files stored in the portable terminal can be played and enjoyed through an external sound device in a vehicle or a house. Furthermore, the FM transmission antenna device is separate from the existing antenna device and is preferably plate-like (for example, a thin copper film) so that it can be attached onto an inner or outer surface of the portable terminal. Thus, there is no need for additional antenna space. Consequently, the present invention contributes to the miniaturization of portable terminals by expanding the functions of the portable terminals without affecting their size.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A frequency modulation (FM) transmission antenna device in a portable terminal, comprising:
an antenna pattern attached to a surface of the portable terminal;
a flexible printed circuit (FPC) that extends from the antenna pattern; and
a connector provided at an end of the FPC, for connecting the FPC to an FM transmitter.

2. The FM transmission antenna device of claim 1, wherein
the antenna pattern is attached onto a portion of an outer surface of the portable terminal, and further comprising a dummy cover for covering at least the portion of the outer surface of the portable terminal.

3. The FM transmission antenna device of claim 2, further comprising
a hole at the portion of the outer surface of the portable terminal, for allowing the FPC to be extended into the portable terminal through the hole.

4. The FM transmission antenna device of claim 1, further comprising
a speaker hole at a predetermined position of the outer surface of the portable terminal, wherein the antenna pattern is a loop antenna attached onto the outer surface of the portable terminal to surround the speaker hole.

5. The FM transmission antenna device of claim 1, wherein
the antenna pattern is a printed circuit pattern formed of a thin copper film and coated with an insulation material on both surfaces.

6. A portable terminal, comprising
a housing having an inner surface and an outer surface;
an antenna pattern attached to the outer surface of the portable terminal;
a flexible printed circuit (FPC) that extends from the antenna pattern;
a frequency modulated (FM) transmitter; and
a connector provided at an end of the FPC, for connecting the FPC to the FM transmitter.

7. The portable terminal of claim 6, further comprising
a dummy cover for covering at least the portion of the outer surface of the portable terminal.

8. The portable terminal of claim 6, wherein
the housing has a hole at the portion of the outer surface of the portable terminal where the antenna pattern is attached to allow the FPC to be extended into the portable terminal through the hole.

9. The portable terminal of claim 6, wherein
the housing has a speaker hole for receiving a speaker at a predetermined position on the outer surface of the portable terminal, and
the antenna pattern is a loop antenna attached onto the outer surface of the portable terminal to surround the speaker hole.

10. The portable terminal of claim 6, wherein
the antenna pattern is a printed circuit pattern formed of a thin copper film and coated with an insulation material on both surfaces.
